(19) United States
(12) Patent Application Publication
(10) Pub. No.: US 2024/0184313 A1
(43) Pub. Date: Jun. 6, 2024

(54) INFORMATION PROCESSING APPARATUS, INFORMATION PROCESSING METHOD, CONTROL METHOD OF CONTROL APPARATUS, AND NON-TRANSITORY STORAGE MEDIUM

(71) Applicant: CANON KABUSHIKI KAISHA, Tokyo (JP)

(72) Inventors: MASAKI FUJITA, Tokyo (JP); KEISUKE ITO, Kanagawa (JP)

(21) Appl. No.: 18/520,177

(22) Filed: Nov. 27, 2023

(30) Foreign Application Priority Data
Dec. 2, 2022 (JP) 2022-193783

(51) Int. Cl. G05D 7/06

(52) U.S. Cl. CPC G05D 7/0623

(57) ABSTRACT

An information processing apparatus includes a processing unit that generates a program to cause an apparatus having a flow channel structure including a plurality of flow channels to perform a plurality of processes, wherein the processing unit: generates a plurality of pieces of flow channel setting information based on device information that represents the flow channel structure and the flow channels used in the flow channel structure in the plurality of processes; generates interlock control information for interlock control for a predetermined flow channel based on the plurality of pieces of flow channel setting information; and generates the program to which the interlock control is added based on the interlock control information.

### BACKGROUND OF THE INVENTION

### Field of the Invention

The present invention relates to an information processing apparatus, an information processing method, a control method of a control apparatus, and a non-transitory storage medium.

### Description of the Related Art

Conventionally, in the field of handling fluid including water treatment systems and chemical plants, there have been known apparatuses having flow channel structures including pumps, valves, pipes, tanks, reaction vessels, and the like. In such apparatuses, various chemical and physical processes are performed using fluid materials, and it is necessary to open and close or change the flow channels of the fluid materials in a timely manner according to the contents of the processes. In order to automate the operation of the apparatus, it is necessary to configure the apparatus so that the operation of the pumps, the valves, and the like can be controlled by a computer, and to prepare in advance a control program to be executed by the computer.

By the way, if the control program for such an apparatus is created and implemented entirely by hand, there is a problem that it is likely to take a long time and mistakes are likely to be made.

In response to this problem, Japanese Patent Application Laid-Open No. 2011-198237 discloses a method of automatically implementing a control program based on configuration data that defines information on a symbolized target device to be controlled, a list of input/output signals, and conditions for operational transitions of the target device to be controlled.

### SUMMARY OF THE INVENTION

The purpose of the present invention is to provide an information processing apparatus and the like that generates, for a process made to be executed by an apparatus with a flow channel structure, a program capable of easily setting constraint conditions to be set by an operator and preventing unintentional mixing of a fluid in a channel in the flow channel structure.

According to one aspect of the present invention, there is provided an information processing apparatus including: a processing unit that generates a program to cause an apparatus having a flow channel structure including a plurality of flow channels to perform a plurality of processes, wherein the processing unit: generates a plurality of pieces of flow channel setting information based on device information that represents the flow channel structure and the flow channels used in the flow channel structure in the plurality of processes; generates interlock control information for interlock control for a predetermined flow channel based on the plurality of pieces of flow channel setting information; and generates the program to which the interlock control is added based on the interlock control information.

According to another aspect of the present invention, there is provided an information processing method with a computer that generates a program to cause an apparatus having a flow channel structure including a plurality of flow channels to perform a plurality of processes, wherein the computer: generates a plurality of pieces of flow channel setting information based on device information that represents the flow channel structure and the flow channels used in the flow channel structure in the plurality of processes; generates interlock control information for interlock control for a predetermined flow channel based on the plurality of pieces of flow channel setting information; and generates the program to which the interlock control is added based on the interlock control information.

Further features of the present invention will become apparent from the following description of exemplary embodiments with reference to the attached drawings.

### BRIEF DESCRIPTION OF THE DRAWINGS

FIG. 1A is a diagram for explaining a piping diagram 3A according to a first embodiment.

FIG. 1B is a diagram for explaining a flow channel diagram 3B according to the first embodiment.

FIG. 1C is a diagram for explaining the flow channel diagram 3B according to the first embodiment.

FIG. 2 is a data flow diagram for explaining a program generation method according to the first embodiment.

FIG. 3 is a schematic diagram for explaining the configuration and the function of a program generation system 1 according to the first embodiment.

FIG. 4 is a diagram for explaining a process table 2 according to the first embodiment.

FIG. 5 is a diagram for explaining a program output setting screen 41 according to the first embodiment.

FIG. 6 is a diagram for explaining a flow channel setting screen 42 according to the first embodiment.

FIG. 7 is a diagram for explaining an IL setting screen 43 according to the first embodiment.

FIG. 8 is a diagram for explaining device type information 52 according to the first embodiment.

FIG. 9 is a diagram for explaining a flow channel table 53 according to the first embodiment.

FIG. 10 is a diagram for explaining a device address table 54 according to the first embodiment.

FIG. 11 is a diagram for explaining an internal address table 55 according to the first embodiment.

FIG. 12 is a diagram for explaining program component information 56 according to the first embodiment.

FIG. 13 is a diagram for explaining IL information 57 according to the first embodiment.

FIG. 14A is a diagram for explaining a program 58A according to the first embodiment.

FIG. 14B is a diagram for explaining the program 58A according to the first embodiment.

FIG. 15 is a flowchart illustrating the basic procedure of a program generation process according to the first embodiment.

FIG. 16 is a flowchart illustrating the procedure of an IL addition processing according to the first embodiment.

FIG. 17A is a diagram for explaining a piping diagram 3A according to a second embodiment.

FIG. 17B is a diagram for explaining a flow channel diagram 3B according to the second embodiment.

FIG. 18 is a diagram for explaining a process table 2 according to the second embodiment.

FIG. 19 is a diagram for explaining an IL program template 565 according to the second embodiment.

FIG. 20A is a diagram for explaining a program 58B according to the second embodiment.

FIG. 20B is a diagram for explaining the program 58B according to the second embodiment.

FIG. 21 is a flowchart illustrating a procedure of the IL addition processing according to the second embodiment.

FIG. 22 is a flowchart illustrating a procedure of an IL program generation subroutine according to the second embodiment.

### DESCRIPTION OF THE EMBODIMENTS

In recent years, as the apparatuses described above have become more multifunctional and the contents of the processing processes have become more complex, the flow channel structures tend to become more complicated. In some cases, in the processing processes by the apparatus, the flow channels overlap in each processing process, and unintentional mixing of fluid materials may become a problem.

For example, in the flow channel structure of the apparatus, suppose that there exists a channel 1 as a channel capable of moving a fluid material A stored in a tank TA to a reaction vessel R, and a channel 2 as a channel capable of moving a fluid material B stored in a tank TB to the reaction vessel R. In the channels 1 and 2, the channels from the tanks TA and TB to the reaction vessel R partially overlap. Here, if the processing processes using the channels 1 and 2 are carried out simultaneously, there is a possibility that unintentional mixing of the fluid materials may occur in the overlapping channels and the product may not be manufactured properly.

In the method disclosed in Japanese Patent Application Laid-Open No. 2011-198237, the control program is automatically implemented based on the configuration data that defines information on the target device to be controlled, the list of input/output signals, and the conditions for the operational transitions of the target device to be controlled. However, the method disclosed in Japanese Patent Application Laid-Open No. 2011-198237 does not consider constraint conditions to be set for each processing process at the stage of creating the configuration data.

Therefore, in the method as described in Japanese Patent Application Laid-Open No. 2011-198237, which generates a program for controlling an apparatus with a flow channel structure, it is not possible to easily set constraint conditions to be set by an operator for a process to be executed by the apparatus.

### First Embodiment

A program generation system, a program generation method, an interlock generation method, and the like according to a first embodiment of the present invention will be described with reference to the drawings. Note that, in the drawings referred to in the following descriptions, elements denoted by the same reference numerals have the same function unless otherwise specified.

First, the main terms used in the following descriptions are defined. A “plant” is a production facility that uses fluid or powder as raw material and includes tanks, pumps, valves, pipes, and the like, and has a flow channel structure that includes a plurality of flow channels. A “flow channel” is a channel through which a fluid or powder passes.

An “interlock control” is a mechanism to prevent accidents and troubles due to incorrect operation or malfunction. The “interlock control” will be hereinafter referred to as “IL”. A “unit process” is a unit of work in which a fluid or powder flows into a flow channel, and uses one flow channel. A “production process” is a process performed by combining a plurality of the unit processes to produce a desired substance. A “tank” is a device that stores a fluid or powder. A “valve” is a device that controls the movement of a fluid or powder in a flow channel, and can be in two states: OPEN to allow movement, and CLOSE to prevent movement. A “pump” is a device that pumps a fluid or powder in a flow channel and can be in two states: ON to pump the fluid or powder, and OFF to stop pumping. A “device” is a collective term for the aforementioned tanks, pumps, valves, and pipes. A “switching attribute” is an attribute of a device, such as a valve, that changes the flow channel through the operation of the device.

An “overlapping flow channel” is a portion of the plant where a plurality of flow channels overlap. An “overlapping device” is a device that is on an overlapping flow channel. An “IL operation device” is a device that operates when the IL is activated. An “IL exclusive device” is a device that is controlled exclusively with the IL operation device when the IL is activated. A “programmable logic controller” is a controller that controls the operation of the plant according to the order, conditions, and the like specified in the program. The “programmable logic controller” will be hereinafter referred to as “PLC”.

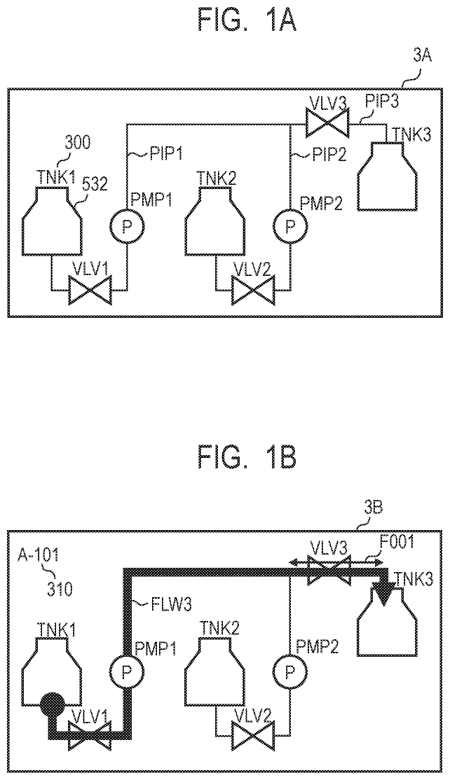

Next, the outline of the IL and the necessity of the IL executed by a program generated by the program generation system according to the present embodiment will be described with reference to FIG. 1A, FIG. 1B, and FIG. 1C.

FIG. 1A is a piping diagram 3A schematically illustrating a certain plant. The piping diagram 3A is device information illustrating the flow channel structure in the plant having the flow channel structure including a plurality of flow channels. The plant has tanks TNK1, TNK2, and TNK3, valves VLV1, VLV2, and VLV3, pumps PMP1 and PMP2, and pipes PIP1, PIP2, and PIP3. The tank TNK1 stores liquid A. One end of the pipe PIP1 is connected to the tank TNK1. The pipe PIP1 is provided with the valve VLV1 and the pump PMP1 in order from one end side to the other end side. The valve VLV1 opens and closes the pipe PIP1. The pump PMP1 pumps the liquid A in the pipe PIP1 from one end side to the other end side of the pipe PIP1. The tank TNK2 stores the liquid B. The liquid A and the liquid B are liquids that differ from each other. One end of pipe PIP2 is connected to tank TNK2. The pipe PIP2 is provided with the valve VLV2 and the pump PMP2 in order from one end side to the other end side. The valve VLV2 opens and closes the pipe PIP2. The pump PMP2 pumps the liquid B in the pipe PIP2 from one end side to the other end side of the pipe PIP2. The other ends of the pipe PIP1 and the pipe PIP2 are respectively connected to one end of the pipe PIP3. The pipe PIP3 is provided with the valve VLV3. The valve VLV3 opens and closes the pipe PIP3. The other end of the pipe PIP3 is connected to the tank TNK3. The piping diagram 3A illustrates such a flow channel structure.

FIG. 1B illustrates a flow channel diagram 3B in which a flow channel FLW3 is drawn with respect to the piping diagram 3A. FIG. 1C illustrates a flow channel diagram 3B in which a flow channel FLW4 is drawn with respect to the piping diagram 3A. The flow channels FLW3 and FLW4 represent liquid flow channels. The flow channel FLW3 is a flow channel that is connected by the pipes PIP1 and PIP3 from the tank TNK1 to the tank TNK3 through the valve VLV1, the pump PMP1 and the valve VLV3 sequentially. The flow channel FLW4 is a flow channel that is connected by the pipes PIP2 and PIP3 from the tank TNK2 to the tank TNK3 through the valve VLV2, the pump PMP2 and the valve VLV3 sequentially. The flow channels FLW3 and FLW4 overlap each other at a portion of the pipe PIP3. The portion where the flow channels FLW3 and FLW4 overlap each other is defined as an overlapping flow channel F001.

When the flow channels FLW3 and FLW4 occur simultaneously in the plant, the liquid A and the liquid B simultaneously flow into the overlapping flow channel F001 from the two tanks TNK1 and TNK2. In this case, since the state in the overlapping flow channels F001 is different from the case in which the flow channels FLW3 and FLW4 are exclusively generated, a desired amount of the liquid A or the liquid B may not flow into the tank TNK3. Furthermore, in this case, the liquid A may flow back from the tank TNK1 to the tank TNK2, or the liquid B may flow back from the tank TNK2 to the tank TNK1. In addition, unintentional mixing of the liquid A and the liquid B may occur in the pipe PIP3, and the product may not be manufactured properly.

The failures resulting from the occurrence of the plurality of flow channels as described above may result from operations that do not use the control program that controls the plant or from problems in the production of the control program that controls the plant. Thus, the control program to control the plant requires the IL. In the present embodiment, by applying the IL to the operations of the valves in the plant, the failures in manufacturing the product are prevented.

Note that, in the present embodiment, a case where liquids flow in flow channels will be described as an example, but the present invention is not limited to the case. The fluids flowing in the flow channels may be gases in addition to liquids. In addition to liquids and gases, the fluids may also include other materials with flowability such as powders and the like. Note also that, in the present embodiment, a case in which a program is generated to cause a plant as a control target, which is a production facility, to perform a plurality of processes will be described as an example, but the present invention is not limited to this case. The control target can be any apparatus that has a flow channel structure including a plurality of flow channels and performs some process.

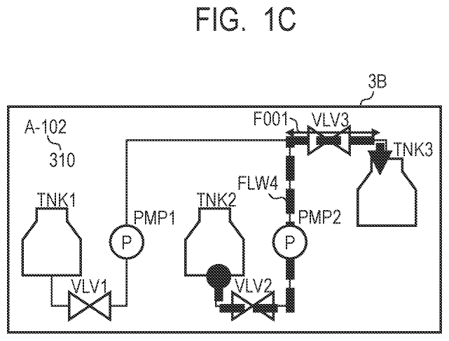

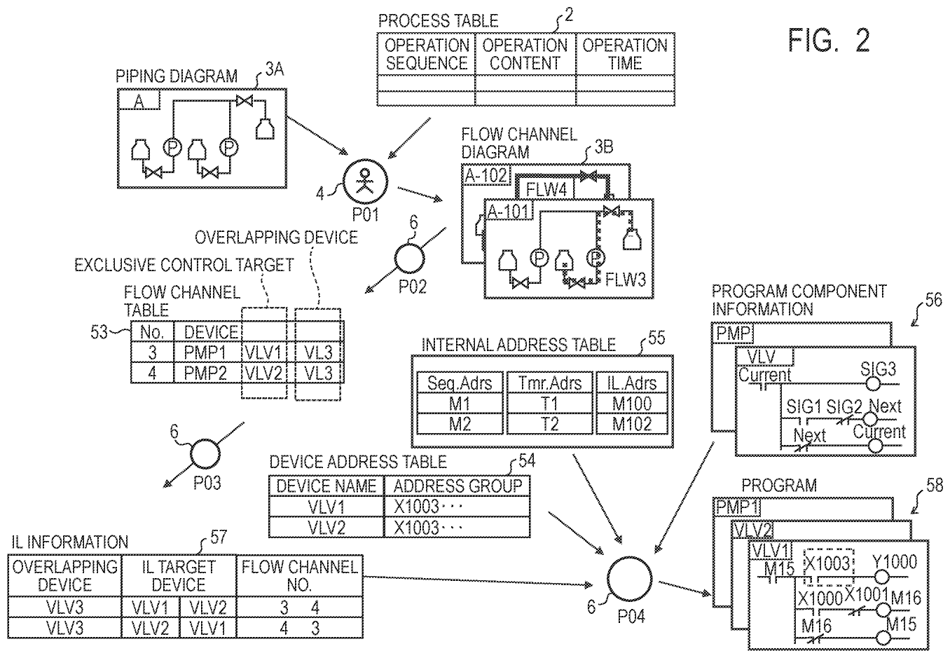

Next, the outline of the program generation method which is an information processing method according to the present embodiment will be described with reference to FIG. 2. FIG. 2 is a data flow diagram for explaining the program generation method according to the present embodiment. The program generation method according to the present embodiment includes a method of adding the IL to the program for controlling the plant. The program generation method according to the present embodiment is performed by a program generation system 1 illustrated in FIG. 3. In FIG. 2, circles represent processes and others represent data.

As illustrated in FIG. 2, the program generation method according to the present embodiment generates a program 58 by using as data the piping diagram 3A, a process table 2, the flow channel diagram 3B, a flow channel table 53, a device address table 54, an internal address table 55, program component information 56, and IL information 57. The program 58 is a control program executed when the plant, which is an apparatus having a flow channel structure including a plurality of flow channels, performs a series of operations, to control the plant. The program 58 causes the plant to perform a plurality of processes.

The piping diagram 3A schematically illustrates the plant to be controlled. The process table 2 is a table describing the unit process in the order of operation. The flow channel diagram 3B is a diagram in which the flow channels are drawn in the piping diagram 3A. The flow channel table 53 stores information about the flow channels. The device address table 54 indicates addresses assigned to the devices in the plant. The internal address table 55 indicates data of program resources necessary for generating the program 58. The program component information 56 is templates of programs necessary for controlling the devices used in the plant. The IL information (interlock control information) 57 is information for adding the IL to the program 58 to be generated. The program 58 is a program for controlling the plant.

The program generation method according to the present embodiment includes a flow channel drawing process P01, a flow channel table generation process P02, an IL information generation process P03, and an IL generation process P04. The flow channel drawing process P01 is a process in which a user draws flow channels along the process table 2 with respect to the piping diagram 3A to generate a plurality of the flow channel diagrams 3B. The flow channel table generation process P02 is a process in which the flow channel table 53 is generated from the flow channel diagram 3B. The IL information generation process P03 is a process in which the IL information 57 is generated from the flow channel table 53. The IL generation process P04 is a process in which the program 58 is generated from the IL information 57, the device address table 54, the internal address table 55, and the program component information 56. In the program generation system 1 described later, a user interface unit 4 executes the flow channel drawing process P01, and a logic unit 6 executes the flow channel table generation process P02, the IL information generation process P03, and the IL generation process P04.

Next, the configuration and the function of the program generation system 1 according to the present embodiment will be described with reference to FIG. 3. FIG. 3 is a schematic diagram for explaining the configuration and the function of the program generation system 1 according to the present embodiment. Note that, in FIG. 3, elements necessary for explaining the features of the present embodiment are represented by blocks, but general elements not directly related to the problem solving principle of the present invention are omitted. Note also that each element illustrated in FIG. 3 is functional and conceptual, and does not necessarily need to be physically constructed as illustrated. For example, the specific embodiment of dispersion and integration of each block is not limited to the illustrated example. The program generation system 1 can be constituted by functionally or physically dispersing or integrating the whole or a part of the program generation system 1 in an arbitrary unit according to a usage situation or the like.

As illustrated in FIG. 3, the program generation system 1 according to the present embodiment includes a display unit 100, an input unit 200, and a PC (Personal Computer) 1003 which is an information processing apparatus. A program generation unit 1004 illustrated in FIG. 3 is a processing unit that performs various processes, and schematically represents functions performed by the PC 1003 by executing the processing program and data used for executing the processing program. Each functional block included in the program generation unit 1004 can be configured by using hardware or software. Each functional block can be configured by reading and executing a control program stored in a computer-readable storage medium such as a storage device or a non-transitory storage medium by a CPU (Central Processing Unit). Alternatively, part or all of the functional blocks may be configured by a hardware such as an ASIC (Application Specific Integrated Circuit) provided in the program generation system 1.

The program generation system 1 generates a program file 1000. The program file 1000 is a file of the program 58 illustrated in FIG. 2. A PLC (Programmable Logic Controller) 1001 is a control apparatus that reads the program 58 from the program file 1000 to execute the program 58, and controls the operation of the plant 1002. Thus, the PLC 1001 causes the plant to perform a production process including a plurality of unit processes.

The PC 1003 of the program generation system 1 includes, as hardware, a CPU (Central Processing Unit) as a central processing unit, a ROM (Read Only Memory) and a RAM (Random Access Memory) as storage units, and an I/O (Input/Output) as an input/output interface. A processing program for realizing an information processing method described later can be stored in the ROM. The RAM is used as a work area of the CPU when the information processing method is executed.

The display unit 100 is a device for displaying various information described later to a user who is an operator when generating the program 58. For example, a liquid crystal display device or an organic EL display device can be used as the display unit 100.

The input unit 200 is a device for the user who is the operator to input various instructions and information when generating the program 58. An input device such as a keyboard or a mouse can be used as the input unit 200.

Note that the display unit 100 can be configured to allow touch input using a display device including a touch panel functioning as the input unit 200. In this case, the user can input various instructions and information by touch input touching a specific area such as a button displayed on various screens in the display unit 100. In addition, even when the display unit 100 is configured to allow touch input, the user can use another input device as the input unit 200 to perform equivalent input.

Next, the functional units of the program generation unit 1004 will be described. The program generation unit 1004 includes a user interface unit 4, a data unit 5 and a logic unit 6 as functional units.

The user interface unit 4 displays various kinds of information on the display unit 100 and receives various kinds of information and instructions from the input unit 200. When generating the program 58, the user interface unit 4 supplies screen information such as a program output setting screen 41, a flow channel setting screen 42, and an IL setting screen 43 to the display unit 100. Note that the configuration of the user interface unit 4 is not limited to this example, but may be such that the screens are integrated, separated, and added, for example, in view of the operability of the user.

The data unit 5 is implemented by being allocated to the storage unit such as the ROM, the RAM, and the like of the PC 1003. The data unit 5 includes the process table 2, the piping diagram 3A, a flow channel diagram group 51, device type information 52, a flow channel table 53, the device address table 54, the internal address table 55, the program component information 56, the IL information 57 and the program 58, which will be described later in detail. Note that the structure of the data unit 5 is not limited to this example, but may be one in which the respective information is integrated or separated in view of maintainability, or may be one in which log information of the user operation and the like are added. The data unit 5 may store the program 58 as the program file 1000 that is converted into a format that can be interpreted and executed by the PLC 1001. The program file 1000 is, for example, a file of a ladder program.

When generating the program 58, the logic unit 6 manages various types of data stored in the data unit 5, generates the program 58 and the program file 1000, and performs processing for adding the IL. The logic unit 6 includes a program file generation unit 61, a data management unit 62, and an IL generation unit 63. The data management unit 62 manages various types of information stored in the data unit 5 to store and acquire information. The program file generation unit 61 performs processing for generating the program 58 and the program file 1000. The IL generation unit 63 performes processing for generating the IL information 57 from various types of information stored in the data unit 5 and adding the IL to the program 58.

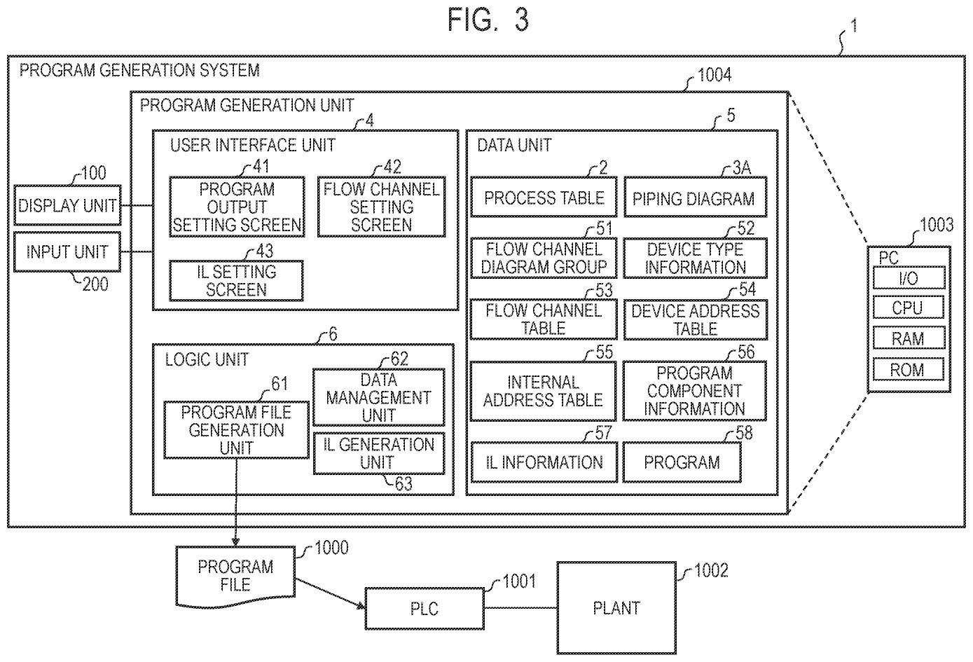

Next, the structure of the process table 2 will be described with reference to FIG. 4. FIG. 4 is a diagram for explaining the process table 2. The process table 2 is a table describing the procedure of the operation to be executed by the plant 1002.

As illustrated in FIG. 4, the process table 2 includes a plurality of rows. Each row of the plurality of rows included in the process table 2 corresponds to one unit process performed by the plant 1002. In order to specify the unit process corresponding to each row, the process table 2 includes an operation sequence 201, an operation content 202, and an operation time 203. A number is set in the operation sequence 201. The number set in the operation sequence 201 is a number specifying each unit process and indicates the execution sequence of each unit process when the generated program 58 is automatically and continuously executed. The operation content 202 indicates the outline of the unit process. The operation time 203 indicates the execution time of the unit process. Note that, when each unit process is manually executed, each unit process may not be executed in the order shown by the operation sequence 201.

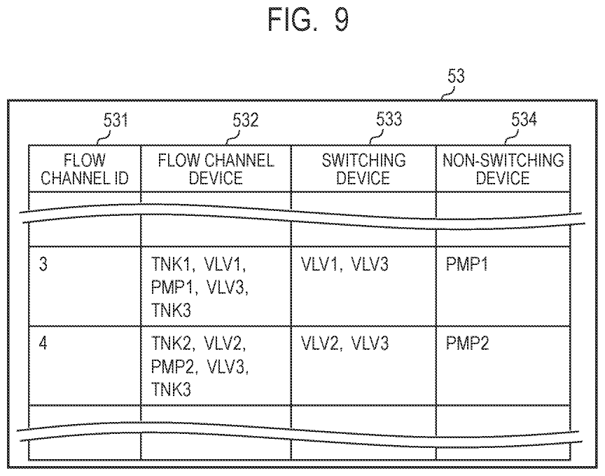

Next, the piping diagram 3A will be described with reference to FIG. 1A. As illustrated in FIG. 1A, the piping diagram 3A schematically represents the plant to be controlled and is device information representing the flow channel structure including the plurality of flow channels provided in the plant. As illustrated in FIG. 1A, in the piping diagram 3A, each of the devices (pumps, valves, tanks, and the like) is shown using a different figure for each type of the device as a component of the plant such as a tank, a valve, a pump, and the like, as exemplified in the device type information 52 (see FIG. 8). Therefore, the piping diagram 3A includes switching attribute information that indicates whether or not the device included in the device type information 52 has a switching attribute 524. The figure is designed so that the type and the function of the device can be grasped intuitively by the user as the operator. A device ID 300 is attached to the figure representing the device displayed in the piping diagram 3A. The device ID 300 is an identifier (ID) for specifying each device constituting the plant.

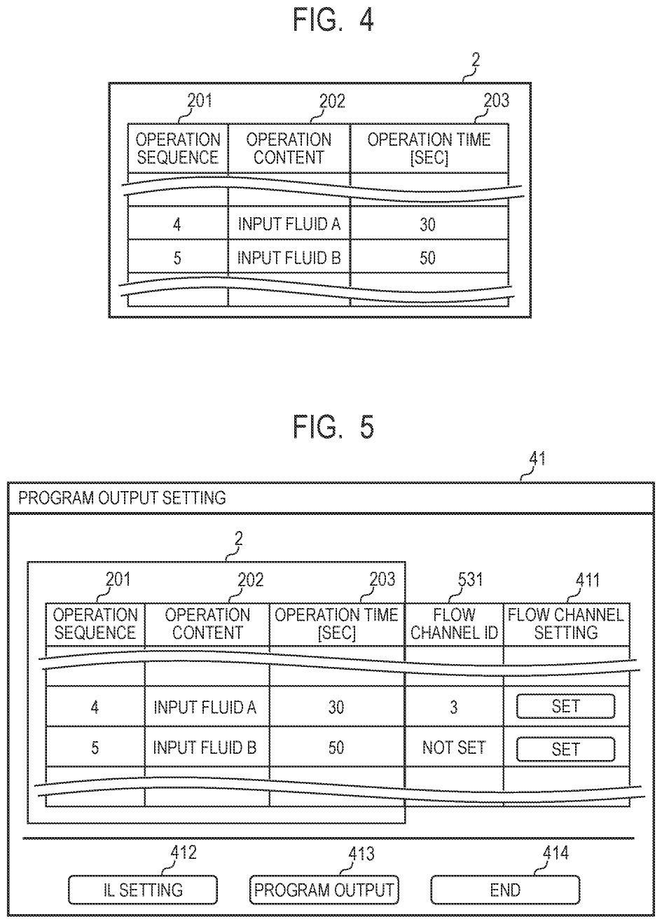

Next, the program output setting screen 41 will be described with reference to FIG. 5. FIG. 5 is a diagram for explaining the program output setting screen 41. The program output setting screen 41 is displayed on the display unit 100 by the user interface unit 4.

As illustrated in FIG. 5, the program output setting screen 41 is a screen in which the user sets a flow channel ID 531 for each unit process described in the process table 2. The program output setting screen 41 includes the process table 2, the flow channel ID 531, flow channel setting buttons 411, an IL setting button 412, a program output button 413, and a program output setting end button 414.

The flow channel ID 531 is arranged in each row of the process table 2. When the flow channel ID 531 is pressed by the input of the user, the flow channel ID 531 can be set by the input of the user. The user can set the flow channel ID 531 by inputting a numeric value, a symbol, a combination thereof, or the like.

The flow channel setting buttons 411 are arranged in each row of the process table 2. When the flow channel setting button 411 is pressed by the input of the user, the display of the display unit 100 changes to the flow channel setting screen 42 described later in which the piping diagram 3A corresponding to the unit process of the same row is inserted.

The IL setting button 412, the program output button 413, and the program output setting end button 414 are arranged separately from the process table 2. When the IL setting button 412 is pressed by the input of the user, the display of the display unit 100 changes to the IL setting screen 43 described later. When the program output button 413 is pressed by the input of the user, the program file generation unit 61 performs a process of storing the program 58 in the data unit 5. Furthermore, the program file generation unit 61 outputs a program file 1000 (e.g., a file of a ladder program) obtained by converting the program 58 into a format that can be interpreted and executed by the PLC 1001. When the program output setting end button 414 is pressed by the input of the user, the program output setting process is interrupted and the program generation system 1 is terminated.

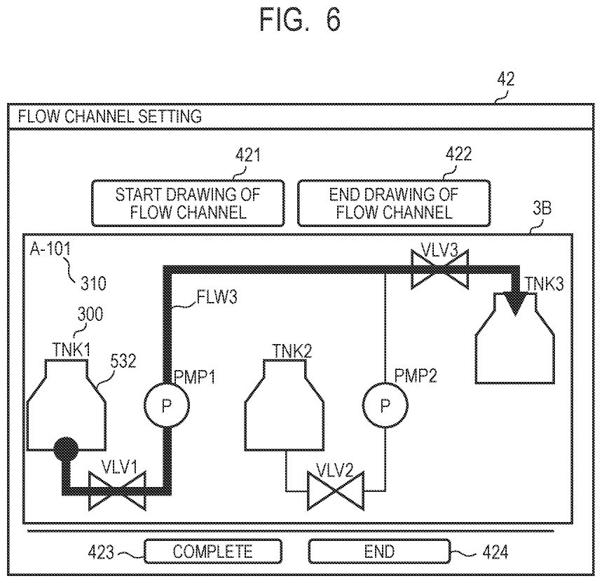

Next, the flow channel setting screen 42 will be described with reference to FIG. 6. FIG. 6 is a diagram for explaining the flow channel setting screen 42. The flow channel setting screen 42 is displayed on the display unit 100 by the user interface unit 4.

As illustrated in FIG. 6, the flow channel setting screen 42 includes the flow channel diagram 3B, a flow channel drawing start button 421, a flow channel drawing end button 422, a flow channel setting completion button 423, and a flow channel setting end button 424.

The flow channel diagram 3B is displayed so that the flow channel can be drawn in response to the input of the user. The flow channel drawing start button 421, the flow channel drawing end button 422, the flow channel setting completion button 423, and the flow channel setting end button 424 are displayed separately from the flow channel diagram 3B.

When the flow channel drawing start button 421 is pressed by the input of the user, drawing of the flow channel in the flow channel diagram 3B starts. When the flow channel drawing end button 422 is pressed by the input of the user, the drawing of the flow channel in the flow channel diagram 3B ends. When the flow channel setting completion button 423 is pressed by the input of the user, processing of a flow channel processing operation flowchart described later starts. When the flow channel setting end button 424 is pressed by the input of the user, the flow channel setting processing is interrupted and the display of the display unit 100 changes to the program output setting screen 41.

The user can set the flow channel in the unit process of the row where the flow channel setting button 411 is arranged by using the flow channel setting screen 42. For example, when a channel from the tank TNK1 to the tank TNK3 is set as a flow channel FLW3, the user first presses the flow channel drawing start button 421 by the input unit 200. Next, the user instructs the channel by dragging the channel from the tank TNK1 to the tank TNK3 using a pointing device (a mouse, for example) of the input unit 200.

The user interface unit 4 draws the channel instructed by the user with the pointing device by converting, for example, the thickness and the color of the line in the flow channel diagram 3B to facilitate visual recognition by the user. When the intended channel is drawn as the flow channel, the user presses the flow channel drawing end button 422 by the input unit 200, and then presses the flow channel setting completion button 423 to determine the flow channel FLW3.

When the user interface unit 4 receives the above operation by the user, the data management unit 62 generates the flow channel table 53 to be described later based on the determined flow channel FLW3. Note that, in the present embodiment, the flow channel is set based on the operation by the user, but the setting is not limited to this example. The data management unit 62 may read information on the setting of the flow channel, and the data management unit 62 may determine all or part of the flow channel FLW3.

Note that the flow channel diagram 3B is prepared in the same number as the unit process in the production process. The flow channel diagram group 51 included in the data unit 5 includes a plurality of the flow channel diagrams 3B. The flow channel diagram group 51 specifies the flow channels used in the flow channel structure of the plant. A flow channel diagram ID 310, which is an ID for specifying the flow channel diagram 3B, is assigned to the flow channel diagram 3B.

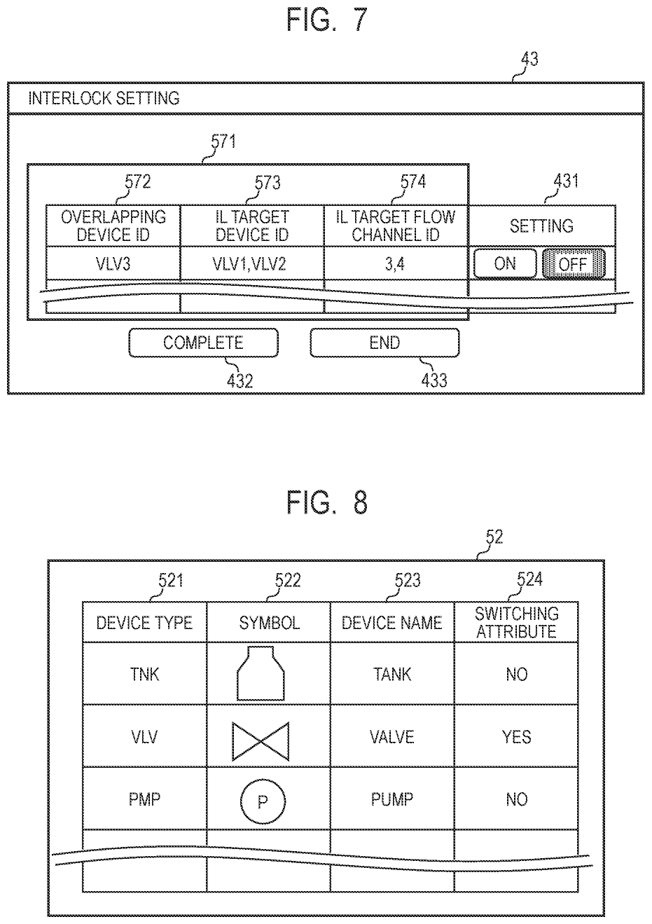

Next, the IL setting screen 43 will be described with reference to FIG. 7. FIG. 7 is a diagram for explaining the IL setting screen 43. The IL setting screen 43 is displayed on the display unit 100 by the user interface unit 4. The IL setting screen 43 is a screen for performing settings for enabling or disabling the IL for the devices to which the IL needs to be added.

As illustrated in FIG. 7, the IL setting screen 43 includes IL device information 571, an IL setting 431, an IL setting completion button 432, and an IL setting end button 433. The IL device information 571 constitutes the IL information 57 described later and is generated by IL information generation processing described later. The IL device information 571 includes an overlapping device ID 572, an IL target device ID 573, and an IL target flow channel ID 574.

The overlapping device ID 572 is an ID of the device having a switching attribute 524 described later in the overlapping flow channel. The IL target device ID 573 is an ID of the device whose operation is restricted by the IL. The IL target channel ID 574 is a flow channel ID of the flow channel having the overlapping device ID 572. The IL setting 431 is a setting whether the IL for the device of the IL target device ID 573 is enabled or disabled. The user sets the IL to be enabled or disabled by selecting an ON button or an OFF button in the IL setting 431 on the IL setting screen 43 by the input from the input unit 200. The user interface unit 4 receives the input from the input unit 200 by the user and stores information indicating the IL set by the IL setting 431 to be enabled or disabled in the data unit 5 as IL setting information (not illustrated). In the present embodiment, by the user setting the IL to be enabled or disabled on the IL setting screen 43, the IL information can be easily set as a restriction condition to be provided by the user for the process to be executed by the plant.

The IL setting completion button 432 stores the enable setting or the disable setting for each IL set by the IL setting 431 in the IL setting information (not illustrated) of the data unit 5 in association with the overlapping device ID 572. The IL setting end button 433, when pressed, ends the IL setting and transits to the program output setting screen 41.

Next, the device type information 52 will be described with reference to FIG. 8. FIG. 8 is a diagram for explaining the device type information 52. The device type information 52 is information relating to a plurality of the devices constituting the plant.

As illustrated in FIG. 8, the device type information 52 includes a plurality of rows. Each row of the plurality of rows included in the device type information 52 corresponds to one type (device type) of each component of the plant, and includes a device type 521, a symbol 522, a device name 523, and a switching attribute 524. The device type in the piping diagram 3A can be specified by the device type 521 constituting a part of the device ID 300.

The symbol 522 is a figure for each device type. The device name 523 is a name for each device type. The switching attribute 524 is switching attribute information indicating whether or not the device type has an attribute for changing the flow channel by switching the flow channel. In the present embodiment, the valves are set as the devices having the switching attributes 524.

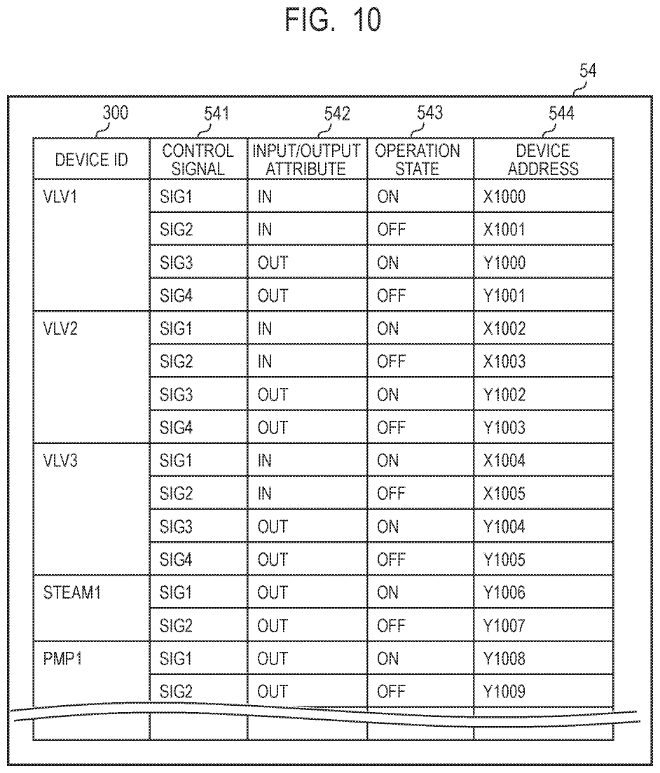

Next, the flow channel table 53 will be described with reference to FIG. 9. FIG. 9 is a diagram for explaining the flow channel table 53. The flow channel table 53 is a table including information on the plurality of flow channels and the devices present in each of the plurality of flow channels in the plant 1002.

As illustrated in FIG. 9, the flow channel table 53 includes a plurality of rows. Each row of the plurality of rows included in the flow channel table 53 corresponds to one flow channel, and is flow channel setting information that is information concerning the setting of the flow channel. The flow channel table 53 includes a plurality of pieces of the flow channel setting information. Each row indicating the flow channel setting information includes a flow channel ID 531, a flow channel device 532, a switching device 533, and a non-switching device 534.

The flow channel ID 531 is an ID for specifying the flow channel. The flow channel device 532 is a set of the devices existing on the concerned flow channel and is derived by flow channel table generation processing described later. The switching device 533 is a set of the devices having control signals and switching attributes 524 among the flow channel device 532 and is derived by flow channel table generation processing described later. The non-switching device 534 is a set of the devices having control signals and not having the switching attributes 524 among the flow channel device 532 and is derived by the flow channel table generation process described later.

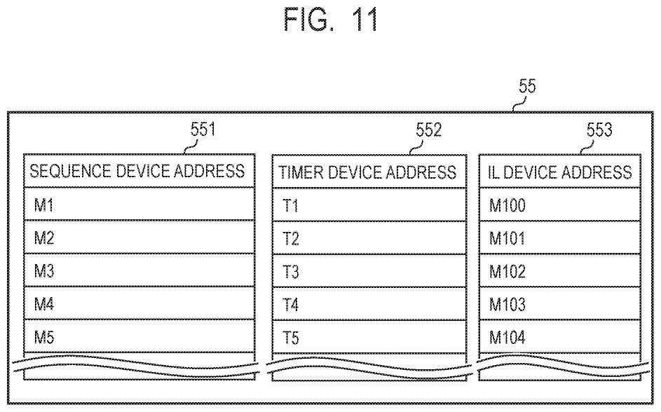

Next, the device address table 54 will be described with reference to FIG. 10. FIG. 10 is a diagram for explaining the device address table 54. The device address table 54 is a table containing information about a plurality of the devices in the plant 1002.

As illustrated in FIG. 10, the device address table 54 includes a device ID 300, a control signal 541, an input/output attribute 542, an operation state 543, and a device address 544. The device ID 300 is an ID for specifying the device in the plant 1002, such as a number, a symbol, and a combination thereof unique to the device. The control signal 541 is a control signal possessed by the device. The input/output attribute 542 is an input/output direction of the control signal and is IN or OUT. The input/output attribute 542 of IN indicates an input direction as seen from the PLC 1001, and the input/output attribute 542 of OUT indicates an output direction as seen from the PLC 1001. The operation state 543 is ON or OFF, and when the input/output attribute 542 is IN, it indicates a state of the device, and when the input/output attribute 542 is OUT, it indicates a command to the device. In the case where the input/output attribute is IN, the operation state 543 of ON indicates that the device is in an operating state, and the pump is ON and the valve is OPEN. In the case where the input/output attribute is IN, the operation state 543 of OFF indicates that the device is in a stopped state, and the pump is OFF and the valve is CLOSE. In the case where the input/output attribute is OUT, the operation state 543 of ON indicates an operation instruction to the device, and it indicates for the pump an instruction to shift to ON and it indicates for the valve an instruction to shift to OPEN. In the case where the input/output attribute is OUT, the operation state 543 of OFF indicates a stop instruction to the device, and it indicates for the pump an instruction to shift to OFF and it indicate for the valve an instruction to shift to CLOSE. For example, the operation state ON for the control signal SIG1 of the valve VLV1 indicates that the valve VLV1 is OPEN. For example, setting the operation state ON for the control signal SIG3 of the valve VLV1 can instruct OPEN for the valve VLV1. The device address 544 is a device address allocated to the control signal 541.

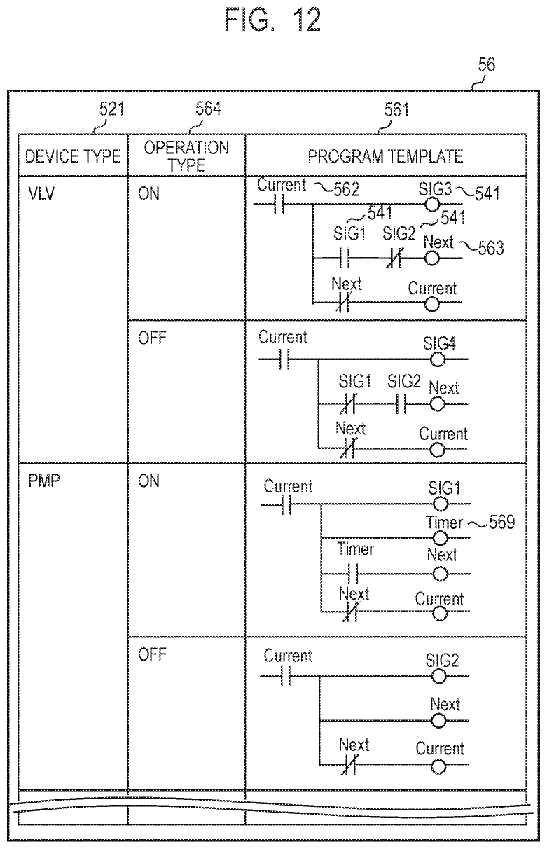

Next, the internal address table 55 will be described with reference to FIG. 11. FIG. 11 is a diagram for explaining the internal address table 55. The internal address table 55 is information for summarizing device addresses used in the program. As illustrated in FIG. 11, the internal address table 55 includes a sequence device address 551, a timer device address 552, and an IL device address 553.

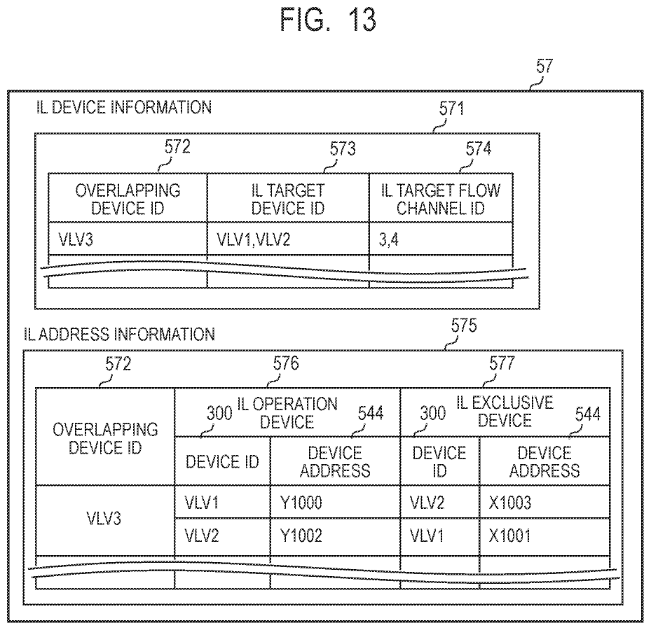

Next, the program component information 56 will be described with reference to FIG. 12. FIG. 12 is a diagram for explaining the program component information 56. The program component information 56 is information used for generating the program 58.

As illustrated in FIG. 12, the program component information 56 includes a device type 521, an operation type 564, and a program template 561. The device type 521 specifies the device type as described above. The operation type 564 is ON or OFF, and indicates the state of the device specified by the device type 521. The operation type 564 of ON indicates the operation state of the device, and indicates ON for the pump and OPEN for the valve. The operation type 564 of OFF indicates the stop state of the device, and indicates OFF for the pump and CLOSE for the valve. The program template 561 is a library in which logic of the control program corresponding to the operation type 564 of the device specified by the device type 521 is expressed in a ladder language.

The program template 561 is logic of the control program for operating the device specified by the device type 521. For example, the program template 561 in which the device type 521 represents the valve “VLV” and the operation type 564 is “ON” is logic of the control program for setting the valve to OPEN.

The program template 561 includes a current sequence address 562, a next sequence address 563, a timer address 569, and a control signal 541. In FIG. 12, “Current” denotes the current sequence address 562, “Next” denotes the next sequence address 563, and “Timer” denotes the timer address 569. These addresses are variables for setting the device addresses to be used within the program 58. In FIG. 12, “SIGn” (where n is a natural number.) represents the control signal 541, to which the corresponding device address 544 is set.

In the present embodiment, the device to be controlled is controlled by step control using a self-holding circuit on the ladder program. Therefore, a control logic equivalent to one step of the step control is stored in one program template 561. Note that the device is not limited to those controlled by the step control. Therefore, the program template 561 is not limited to a format for the step control, and can be appropriately changed by the user according to a control method suitable for the device to be controlled.

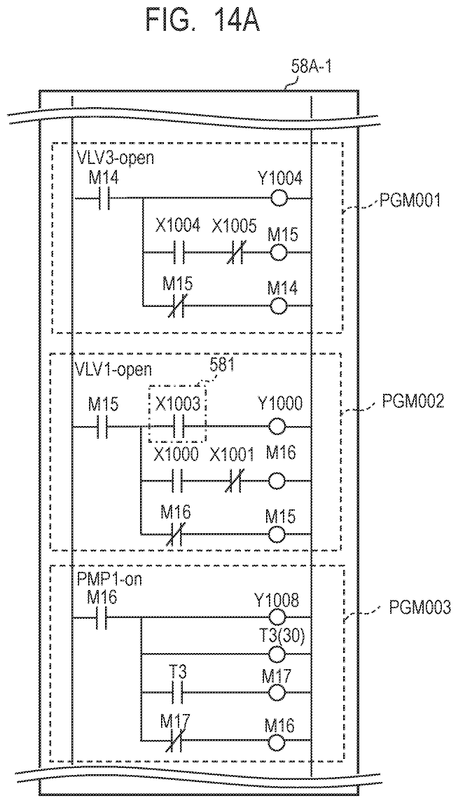

Next, the IL information 57 will be described with reference to FIG. 13. FIG. 13 is a diagram for explaining the IL information 57. The IL information 57 is information for the IL for a predetermined flow channel and includes information about the device related to the IL.

As illustrated in FIG. 13, the IL information 57 includes IL device information 571 and IL address information 575. The IL device information 571 includes an overlapping device ID 572, an IL target device ID 573, and an IL target flow channel ID 574. The IL address information 575 includes an IL operation device 576 and an IL exclusive device 577 when the IL corresponding to the overlapping device ID 572 operates. The IL operation device 576 and the IL exclusive device 577 each comprise a device ID 300 for specifying the device and a device address 544 for controlling the device. The IL address information 575 includes information indicating a correspondence relationship between the IL operation device 576 operated when the IL operates and the IL exclusive device 577 controlled exclusively with the IL operation device 576.

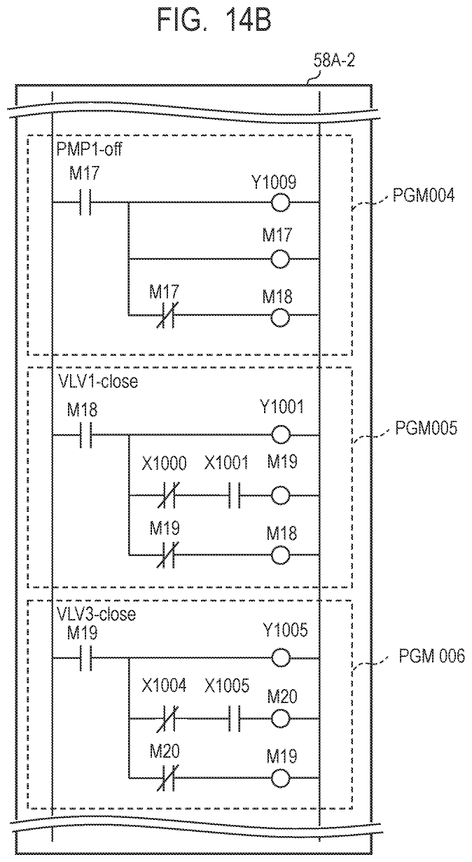

Next, a program 58A, which is an example of the program 58, will be described with reference to FIG. 14A and FIG. 14B. FIG. 14A and FIG. 14B are diagrams for explaining the program 58A and illustrate portions 58A-1 and 58A-2 of the program 58A, respectively. In the program 58A, the portion 58A-2 follows the portion 58A-1. The program 58A is a part of the program corresponding to the flow channel FLW3 in FIG. 1B.

As illustrated in FIG. 14A and FIG. 14B, the program 58A includes programs PGM001, PGM002, PGM003, PGM004, PGM005, and PGM006. These programs are programs in each of which the device addresses are set in the program template of the device type corresponding to the device ID on the flow channel FLW3.

For example, the program PGM001 is a program that sets the valve VLV3 to OPEN. In the program PGM001, when the contact M14 is turned ON, the device address Y1004 (a command signal that sets the valve VLV3 to OPEN) is turned ON, and the valve VLV3 becomes OPEN. In this state, when the device address X1004 (a signal that confirms the OPEN state of the valve VLV3) is turned ON and the device address X1005 (a signal that confirms the CLOSE state of the valve VLV3) is turned OFF, the contact M15 is turned ON. This terminates the program PGM001 and the process is transferred to the contact M15 of the program PGM002 which is the next step.

The program PGM002 is a program that sets the valve VLV1 to OPEN, but unlike the program PGM001, an IL circuit 581 is added to the program PGM002. As described with reference to FIG. 1A and FIG. 1B, the valves VLV1 and VLV2 are exclusively controlled by the IL circuit 581 to prevent overlapping flow channels F001. In the program PGM002, the device address Y1000 (a command signal that set the valve VLV1 to OPEN) can be turned ON only when the device address X1003 (a signal that confirms the CLOSE state of the valve VLV2) is turned ON.

The program PGM003 is a program that sets the pump PMP1 to ON. When the contact M16 is turned ON, the device address Y1008 (a command signal that sets the pump PMP1 to ON) is turned ON, and the pump PMP1 operates. At the same time, the timer T3 is enabled, and when the timer T3 continues for 30 seconds, the timer T3 expires. When the timer T3 expires, the contact M17 turns ON, and the process is transferred to the next program PGM004.

The program PGM004 is a program that sets the pump PMP1 to OFF. The program PGM005 is a program that sets the valve VLV1 to CLOSE. The program PGM006 is a program that sets the valve VLV3 to CLOSE.

The flow channel FLW3 is formed by the program PGM001 through the program PGM006 described above.

The program generation unit 1004 converts the program 58A into a format that can be interpreted and executed by the PLC 1001, and outputs it as the program file 1000. When the PLC 1001 executes the program file 1000, the plant 1002 executes the operation set in the process table 2.

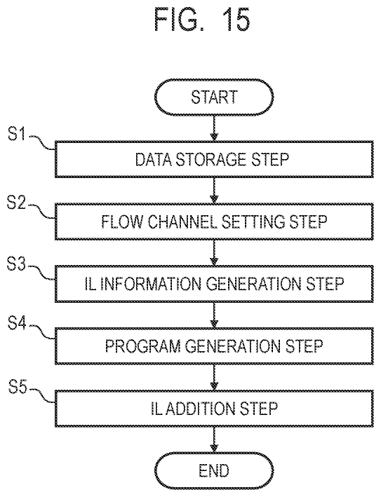

Next, the processing procedure of the program file generation processing according to the present embodiment will be described with reference to FIG. 15. FIG. 15 is a flowchart illustrating the basic procedure of the program file generation processing. As illustrated in FIG. 15, the program file generation process according to the present embodiment includes a data storage step S1, a flow channel setting step S2, an IL information generation step S3, a program generation step S4, and an IL addition step S5 as steps which are sequentially executed. Each of the steps will be described below in sequence.

First, in the data storage step S1, various kinds of information necessary for generating the program 58A are stored in the data unit 5. In the data storage step S1, the user interface unit 4 displays a data designation dialog (not illustrated) on the display unit 100. In response to the data designation dialog, the user designates the arbitrary process table 2, the arbitrary piping diagram 3A, and the arbitrary device address table 54 using the input unit 200. The process table 2, the piping diagram 3A, and the device address table 54 designated by the user may be, for example, those previously stored in the storage unit of the PC 1003, or those acquired by the PC 1003 from an external device and stored in the storage unit. The data management unit 62 stores the process table 2, the piping diagram 3A, and the device address table 54 designated by the user in the data unit 5. Thus, the various kinds of information are stored in the data unit 5 in the data storage step S1. The data storage step S1 determines the plant 1002 for which the program 58A as the control program is to be prepared and the operation content of the plant 1002.

Next, in the flow channel setting step S2, the flow channel used in each unit process performed by the plant 1002 is set. In the flow channel setting step S2, the user interface unit 4 displays the program output setting screen 41 on the display unit 100 and receives the pressing of the flow channel setting button 411 by the user in the screen to process the flow channel setting. When the flow channel setting button 411 is pressed by the input of the user, the user interface unit 4 displays the flow channel setting screen 42 on the display unit 100. In the flow channel setting screen 42, the user interface unit 4 displays the flow channel diagram 3B in which the flow channel diagram ID 310 is allocated to the piping diagram 3A stored in the data storage step S1. The user sets the flow channel in the flow channel diagram 3B using the displayed flow channel setting screen 42. When the user completes setting the flow channel, the user presses the flow channel setting completion button 423. When the flow channel setting completion button 423 is pressed, the data management unit 62 stores the flow channel diagram 3B in the flow channel diagram group 51. Further, the data management unit 62 executes the processing of generating the flow channel table 53.

The processing of generating the flow channel table 53 will now be described. First, the data management unit 62 assigns the flow channel ID 531 to the flow channel set by the user. Next, the data management unit 62 stores the device IDs 300 of all the devices existing on the flow channel set by the user in the flow channel device 532 of the flow channel table 53 corresponding to the flow channel ID 531. Next, the data management unit 62 determines whether or not the device having the control signal and having the device ID 300 stored in the flow channel device 532 has the switching attribute by referring to the device type information 52. As a result of the determination, the data management unit 62 stores the device ID 300 of the device having the switching attribute in the switching device 533 of the flow channel table 53. The data management unit 62 stores the device ID 300 of the device having no switching attribute in the non-switching device 534 of the flow channel table 53. Note that, in the present embodiment, the tank is a device that has no control signal for simplicity. Taking the flow channel FLW3 illustrated in FIG. 1B as an example, as illustrated in FIG. 9, 3 is given as the flow channel ID 531, and the tank TNK1, the valve VLV1, the pump PMP1, the valve VLV3, and the tank TNK3 are stored in the flow channel device 532. The valves VLV1 and VLV3 are stored in the switching device 533. The PMP1 is stored in the non-switching device 534. Thus, the data management unit 62 generates the flow channel table 53 containing the flow channel setting information corresponding to each unit process.

Next, in the IL information generation step S3, the IL information 57 necessary for adding the IL for the predetermined flow channel to the program 58A generated by the program generation step S4 described later is generated. The IL information generation step S3 includes generation processing of the IL device information 571 and generation processing of the IL address information 575. Each generation processing will be described below. Note that, in the following description, storing the device means storing the device ID 300 of the device.

The generation processing of the IL device information 571 will be described below. In the generation processing of the IL device information 571, first, the IL generation unit 63 refers to the flow channel table 53 and checks whether or not there is the switching device on the overlapping flow channel for all the flow channels. When there is the switching device on the overlapping flow channel as a result of the check, the IL generation unit 63 stores the switching device as the overlapping device in the overlapping device ID 572 of the IL device information 571. Next, the IL generation unit 63 stores all the switching devices other than the overlapping devices as the IL target devices in the IL target device ID 573 of the IL device information 571. Next, the IL generation unit 63 stores the flow channel ID 531 of the channel having the overlapping device in the IL target channel ID 574 of the IL device information 571. When the IL generation unit 63 completes the storage processing of the devices in the IL target device ID 573 and the storage processing of the flow channel ID 531 in the IL target channel ID 574 for all the overlapping devices, the generation processing of the IL device information 571 ends.

The generation processing of the IL device information 571 will be described with reference to the flow channel table 53 illustrated in FIG. 9 as an example. In the case illustrated in FIG. 9, the IL generation unit 63 stores, in the overlapping device ID 572, the valve VLV3 which is the flow channel device that overlaps in two flow channels having the flow channel IDs 531 of 3 and 4. The IL generation unit 63 stores, in the IL target device ID 573, the valves VLV1 and VLV2 which are the switching devices other than the valve VLV3 in the two flow channels having the flow channel IDs 531 of 3 and 4. Further, the IL generation unit 63 stores, in the IL target channel ID 574, 3 and 4 which are the flow channel IDs 531 of the flow channels having the valve VLV3.

The generation process of the IL address information 575 will be described below. In the generation processing of the IL address information 575, the IL generation unit 63 performs the following processing for all the overlapping devices registered in the IL device information 571. First, the IL generation unit 63 refers to the IL device information 571 and stores all the IL target devices corresponding to the overlapping device as the IL operation devices in the IL operation device 576 of the IL address information 575. Next, the IL generation unit 63 refers to the device address table 54 and stores, among the control signals of the IL operation devices, the device address to which the PLC 1001 issues an ON instruction (the input/output attribute 542 is OUT and the operation state 543 is ON). Next, the IL generation unit 63 stores the device that is controlled exclusively with the IL operation device as the IL exclusive device in the IL exclusive devices 577 of the IL address information 575. In the respective row of the IL exclusive device 577, the IL target devices excluding the IL operation devices are stored. At this time, depending on the configuration of the piping diagram 3A, a plurality of the IL exclusive devices may be stored for one IL operation device. Next, the IL generation unit 63 refers to the device address table 54 and stores, among the control signals of the IL exclusive devices, the device address for notifying the PLC 1001 of the OFF state (the input/output attribute is IN and the operation state is OFF). The IL generation unit 63 ends the generation processing of the IL address information 575 when the storage processing of the devices and the like to the IL operation device 576 and the storage processing of the devices and the like to the IL exclusive device 577 are completed for all the overlapping devices.

The generation processing of the IL address information 575 will be described with reference to the IL information 57 illustrated in FIG. 13 as an example. In the row where the overlapping device ID 572 of the IL device information 571 is “VLV3”, the IL target devices are “VLV1, VLV2”. Therefore, “VLV1, VLV2” are stored in the IL operation device 576 of the IL address information 575. On the other hand, the IL exclusive device which is the device controlled exclusively with the IL operation device is stored in the IL exclusive device 577 of the IL address information 575. Therefore, in the row where the IL operation device 576 is “VLV1”, “VLV2” is stored in the IL exclusive device 577. Further, in the row where the IL operation device 576 is “VLV2”, “VLV1” is stored in the IL exclusive device 577.

The IL device information 571 and the IL address information 575 are generated as described above, and the IL information generation step S3 is completed. When the IL information generation step S3 is completed, the IL can be enabled or disabled for each IL target device from the IL setting screen 43 as described above.

Next, in the program generation step S4, the program 58A is generated. In the program generation step S4, when the user presses the program output button 413 of the program output setting screen 41, the program file generation unit 61 executes program generation processing. In this case, if the user has not set the IL to be enabled or disabled on the IL setting screen 43, the user interface unit 4 can prevent the IL from not being set by popping up a warning on the display unit 100 or other means. The program generation processing executed by the program file generation unit 61 will be described below.

First, the program file generation unit 61 refers to the flow channel table 53, and acquires from the program component information 56 the program template 561 in which the operation type 564 of the device type 521 corresponding to the switching device is ON in order from the switching device arranged on the downstream side of the flow channel. Further, the program file generation unit 61 sets the device addresses in the acquired program template 561.

Next, the program file generation unit 61 refers to the flow channel table 53 and acquires from the program component information 56 all of the program templates 561 in each of which the operation type 564 of the device type 521 corresponding to the non-switching device is ON. Further, the program file generation unit 61 sets the device addresses in the acquired program template 561.

Next, the program file generation unit 61 refers to the flow channel table 53 and acquires from the program component information 56 all of the program templates 561 in each of which the operation type 564 of the device type 521 corresponding to the non-switching device is OFF. Further, the program file generation unit 61 sets the device addresses in the acquired program template 561.

Next, the program file generation unit 61 refers to the flow channel table 53 and acquires from the program component information 56 the program template 561 in which the operation type 564 of the device type 521 corresponding to the switching device is OFF in order from the switching device arranged on the upstream side of the flow channel. Further, the program file generation unit 61 sets the device addresses in the acquired program template 561.

Here, the procedure for setting the device addresses in the program template 561 will be described. The program file generation unit 61 sets the device addresses to the current sequence address 562, the next sequence address 563, the timer address 569, and the control signal 541 that constitute the program template 561.

The program file generation unit 61 sets the sequence device addresses 551 of the internal address table 55 to the current sequence address 562 and the next sequence address 563 of the program template 561. At this time, the program file generation unit 61 sets the sequence device addresses 551 in ascending order and so as not to make it overlap in the subsequent program generation processing.

The program file generation unit 61 sets the timer device address 552 of the internal address table 55 to the timer address 569. At this time, the program file generation unit 61 sets the timer device address 552 in ascending order and so as not to make it overlap in the subsequent program generation processing. In addition, the program file generation unit 61 sets the operation time 203 corresponding to each unit process of the process table 2 as a set value of the timer.

In addition, the program file generation unit 61 sets the device address corresponding to the control signal of the corresponding device ID of the device address table 54 to the control signal 541.

Finally, the program file generation unit 61 outputs the program template 561 in which the device addresses are set by the above processing to the program 58A. The program file generation unit 61 stores the thus generated program 58A in the data unit 5.

An example of the above program generation processing is described with the program 58A corresponding to flow channel FLW3 in the flow channel diagram 3B illustrated in FIG. 1B as a specific example. In the flow channel FLW3, the switching devices are the valves VLV1 and VLV3. In the flow channel FLW3, the non-switching device is the pump PMP1.

First, the program file generation unit 61 generates programs that set the switching devices on the flow channel FLW3 to ON from the downstream side of the flow channel. That is, the program file generation unit 61 generates the programs that set the valves VLV3 and VLV1, which are the switching devices on the flow channel FLW3, to OPEN in this order.

Here, the generation procedure of the program that sets the valve VLV3 to OPEN will be described with reference to the program PGM001 of FIG. 12 and FIG. 14A. Here, it is assumed that the starting point of the sequence device address 551 is M14. First, the program file generation unit 61 acquires the program template 561 in which the device type 521 is VLV and the operation type 564 is ON. Next, the program file generation unit 61 refers to the internal address table 55 and sets M14 to Current and M15 to Next in the program template 561. Next, the program file generation unit 61 refers to the device address table 54 and sets the device addresses X1004, X1005, and Y1004 of the valve VLV3 to the control signals SIG1, SIG2, and SIG3 in the program template 561, respectively. Thus, the program PGM001 that sets the valve VLV3 to OPEN is generated.

The program file generation unit 61 generates the program PGM002 that sets the valve VLV1 to OPEN in the same procedure as for the program PGM001. Thus, the generation processing of the programs, which sets the switching devices on the flow channel FLW3 to OPEN, is completed.

Next, the program file generation unit 61 generates a program that sets the non-switching device on the flow channel FLW3 to ON. That is, the program file generation unit 61 generates the program that sets the pump PMP1, which is the non-switching device on the flow channel FLW3, to ON. The program file generation unit 61 acquires the program template 561 in which the device type 521 is PMP and the operation type 564 is ON, and sets the device addresses in the same procedure as for the program PGM001. Thus, the program file generation unit 61 generates the program PGM003 that sets the pump PMP1 to ON.

Next, the program file generation unit 61 generates a program that sets the non-switching device on the flow channel FLW3 to OFF. That is, the program file generation unit 61 generates the program that sets the PMP1 to OFF. The program file generation unit 61 acquires the program template 561 in which the device type 521 is PMP and the operation type 564 is OFF, and sets the device addresses in the same procedure as for the program PGM001. Thus, the program file generation unit 61 generates the program PGM004 that sets the pump PMP1 to OFF.

Next, the program file generation unit 61 generates programs that set the switching devices on the flow channel FLW3 to OFF from the upstream side of the flow channel. That is, the program file generation unit 61 generates the programs that set the valves VLV1 and VLV3 to CLOSE in this order. The program file generation unit 61 acquires the program template 561 in which the device type 521 is VLV and the operation type 564 is OFF, and sets the device addresses in the same procedure as for the program PGM001. Thus, the program file generation unit 61 generates the program PGM005 that sets the valve VLV1 to CLOSE and the program PGM006 that sets the valve VLV3 to CLOSE.

The above processing generates the program 58A corresponding to the flow channel FLW3.

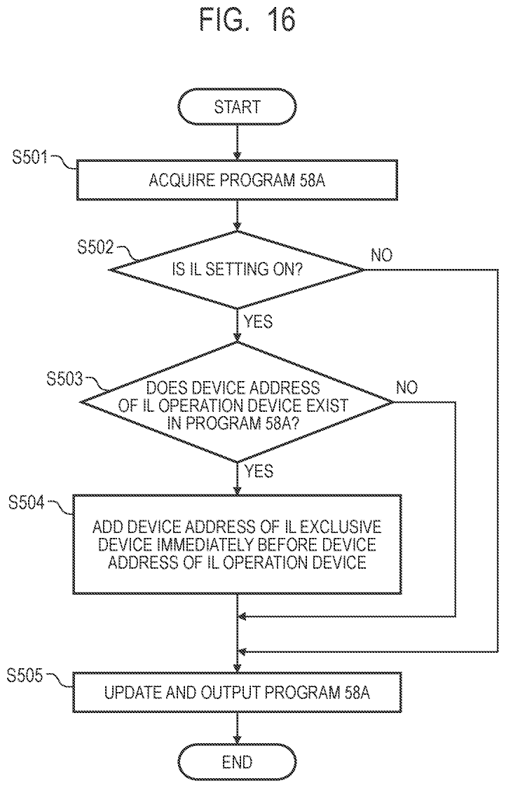

Next, in the IL addition step S5, the IL is added to the program 58A based on the IL information 57. The IL addition processing in the IL addition step S5 will be described below with reference to FIG. 16. FIG. 16 is a flowchart illustrating the procedure of the IL addition processing. In the present embodiment, the addition of the IL to the program 58A generates the program 58A, which can prevent the unintentional mixing of the fluids in the channel in the flow channel structure of the plant.

As illustrated in FIG. 16, first, in step S501, the IL generation unit 63 acquires the program 58A to which the IL should be added. The IL generation unit 63 can acquire the program 58A from the data unit 5.

Next, in step S502, the IL generation unit 63 refers to the IL setting information (not illustrated) for the overlapping device registered in the IL device information 571 and checks whether the IL setting is effectively set. When the IL setting is effectively set, the IL generation unit 63 makes the processing proceed to step S503. When the IL setting is not effectively set, the IL generation unit 63 makes the processing proceed to step S505.

When the IL setting is effectively set, the IL generation unit 63 sequentially performs step S503 and step S504 for all the overlapping devices registered in the IL address information 575 and the IL operation devices corresponding to the respective overlapping devices.

In step S503, the IL generation unit 63 refers to the IL address information 575 and checks whether the device address of the IL operation device exists in the program 58A. When the device address of the IL operation device exists in the program 58A, the IL generation unit 63 makes the processing proceed to step S504, and when not, the IL generation unit 63 makes the processing proceed to step S505.

Next, in step S504, the IL generation unit 63 adds a contact immediately before the device address of the IL operation device in the program 58A, and sets the device address of the IL exclusive device to the contact. After setting the device address in step S504, the IL generation unit 63 makes the processing proceed to step S505.

Next, in step S505, the program file generation unit 61 creates the program file 1000 in which the program 58A updated in step S502 to step S502 by the IL generation unit 63 is converted into a format that can be interpreted and executed by the PLC 1001. Subsequently, the program file generation unit 61 performs a processing of outputting the created program file 1000 to the outside so that the PLC 1001 can use the program file 1000.

Note that, after completion of the IL addition step S5, the user interface unit 4 can display the generated program 58A on the display unit 100. The convenience of the user can be improved by displaying the program 58A on the display unit 100. At this time, the user interface unit 4 may emphatically display the IL portion added in the IL addition step S5 with highlighting the IL portion or the like.

The Specific processing of step S503 and step S504 will be described with reference to examples of FIG. 13 to FIG. 14B. The device address 544 of the device ID 300 of the IL operation device 576 is “Y1000”, the device ID 300 of the corresponding IL exclusive device 577 is “VLV2”, and its device address 544 is “X1003”. Since “Y1000” is present in the program PGM002 of the program 58A, it is confirmed that “Y1000” is present as the device address of the IL operation device in step S503. In step S504, a contact point is added immediately before “Y1000” at a position indicated by a dashed-dotted line in FIG. 14A, and “X1003” is added and set to the contact point as the device address of the IL exclusive device and set.

Thus, according to the present embodiment, the IL information can be easily set as a constraint condition to be set by the user who is an operator in the process to be executed by the plant having the flow channel structure. Furthermore, according to the present embodiment, it is possible to generate the program that can prevent unintentional mixing of the fluids in the flow channel in the flow channel structure of the plant.

### Second Embodiment

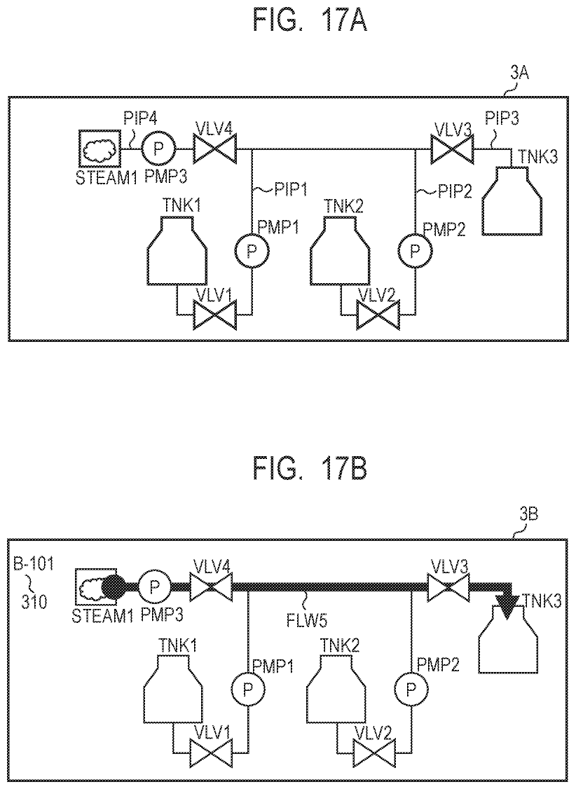

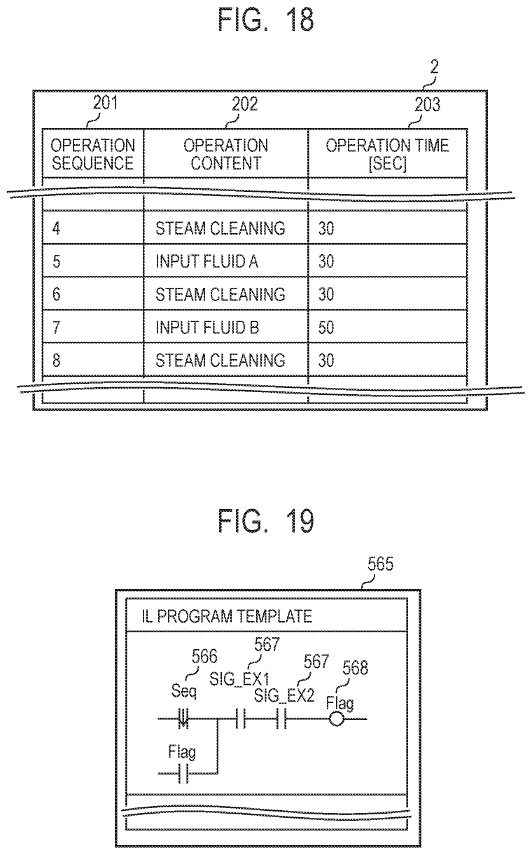

A program generation system, a program generation method, an interlock generation method, and the like according to a second embodiment of the present invention will be described with reference to FIG. 17A, FIG. 17B, and FIG. 18. Note that the same components as those in the first embodiment are labeled with the same reference numerals and the description thereof will be omitted or simplified.

FIG. 17A is a piping diagram 3A schematically representing a plant. In the piping diagram 3A illustrated in FIG. 17A, a steam source STEAM1, a pump PMP3, and a valve VLV4 are added to the piping diagram 3A illustrated in FIG. 1A. The steam source STEAM1 is connected to one end of the pipe PIP4. The other end of the pipe PIP4 is connected to the downstream portion of the pipe PIP1 with respect to the pump PMP1. The pipe PIP4 is provided with the pump PMP3 and the valve VLV4 in order from the one end side to the other end side. The pump PMP4 pumps steam in the pipe PIP4 from the one end side to the other end side. The valve VLV4 opens and closes the pipe PIP4. The steam source STEAM1 generates steam used for cleaning the pipes and supplies it into the pipe PIP4.

Note that, in the present embodiment, a cleaning process using the steam generated by the steam source STEAM1 will be described, but the present invention is not limited to this example. Instead of the steam source STEAM1, a supply source for supplying a fluid used for cleaning can be provided to perform the cleaning process using the fluid. In addition, addition of the IL can also be performed in a predetermined process other than the cleaning process.

FIG. 17B illustrates a flow channel diagram 3B in which a flow channel FLW5 is drawn starting from the steam source STEAM1, sequentially passing through the pump PMP3, the valve VLV4 and the valve VLV3, and ending at the tank TNK3. When the steam that is a fluid flows through the flow channel FLW5, the pump PMP3 is ON, the valves VLV4 and VLV3 are OPEN, the pumps PMP1 and PMP2 are OFF, and the valves VLV1 and VLV2 are CLOSE.

FIG. 18 illustrates a part of the process table 2 when the steam cleaning is performed by the steam source STEAM1. In the process of the process table 2 illustrated in FIG. 18, the operation sequence 201 is “4” and the steam cleaning is performed for 30 seconds, followed by the input of the liquid A for 30 seconds, the steam cleaning for 30 seconds, the input of the liquid B for 50 seconds, and the steam cleaning for 30 seconds in sequence. By inserting the steam cleaning between the input of the liquid A and the liquid B in this way, the liquid A in the tank TNK1 and the liquid B in the tank TNK2 do not mix in the pipe. Therefore, the quality of the product may be stabilized.

As the interlock in the case of inserting the steam cleaning as described above, it is considered to apply the rule that the steam cleaning process must be performed before the liquid is input. Specifically, a steam-cleaned flag, which is a flag indicating whether or not the process is performed, which becomes effective when the steam cleaning process is performed, is provided in the program that controls the plant. In the processing of the steam-cleaned flag, when the steam cleaning is performed, the steam-cleaned flag is set to ON, and when the liquid of the tank TNK1 or the tank TNK2 flows, the steam-cleaned flag is set to OFF. Thereafter, as in the case of the first embodiment, as a condition for inputting the liquid, an IL circuit with the condition that the steam-cleaned flag is set to ON may be added to the conditions for opening VLV1 and VLV2.

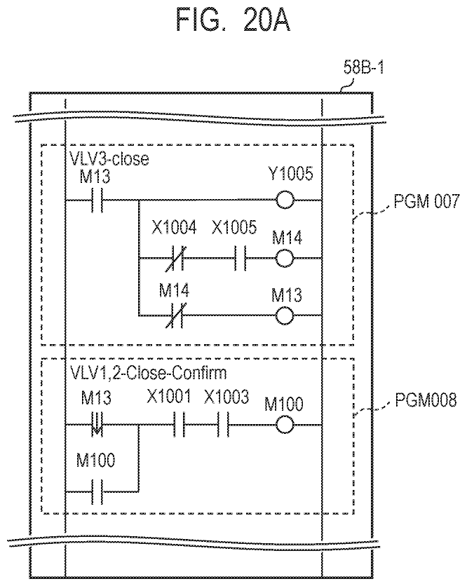

In the present embodiment, an IL program template 565 is added to the program component information 56 for the flag management. The IL program template 565 will be described below with reference to FIG. 19.

The IL program template 565 includes a cleaning sequence address 566, an IL target device control signal 567, and a flag 568. The cleaning sequence address 566 is a device address for confirming the end of the cleaning process by a falling contact. The flag 568 is a flag for managing on the program 58 whether an arbitrary unit process has been performed. Since the flag 568 needs to be set to OFF when liquids that differ from each other flow in the overlapping channels, the IL target device control signal 567 confirms that the IL target device is in the OFF state.

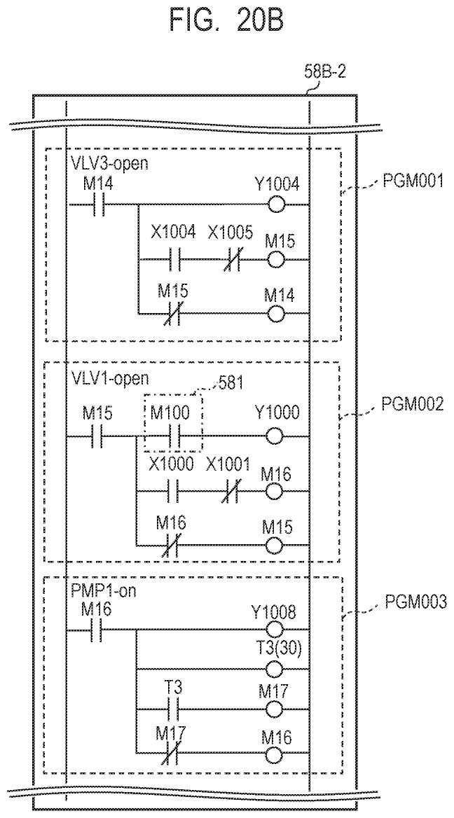

Next, the behavior of a program 58B, which is an example of the program 58 according to the present embodiment, will be described with reference to FIG. 11, FIG. 20A, and FIG. 20B. FIG. 20A and FIG. 20B are diagrams for explaining the program 58B, and illustrate portions 58B-1 and 58B-2 of the program 58B, respectively.

The program 58B is part of a ladder program corresponding to the flow channel FLW3 of FIG. 1B and the flow channel FLW5 of FIG. 17B. As illustrated in FIG. 20A and FIG. 20B, the program 58B includes programs PGM007, PGM008, PGM001, PGM002, and PGM003.

The program PGM007 is a program that sets valve VLV3 to CLOSE. In the present embodiment, the valve VLV3 is the last device to be processed in the steam cleaning process in which the operation sequence 201 illustrated in FIG. 18 is “4”. The program PGM008 is a program that manages the steam-cleaned flag M100.

Consider when the processing of the program PGM007 is completed, that is, when the contact point of the contact M13 is turned OFF. At this time, when both X1001 (the state signal that confirms the CLOSE state of the valve VLV1) and X1003 (the state signal that confirms the CLOSE state of the valve VLV2) are ON, the steam cleaning is completed and the steam-cleaned flag M100 is turned ON. When either X1001 or X1003 is turned OFF, the steam-cleaned flag is turned OFF because the liquid flows in the overlapping flow channel.

In the present embodiment, unlike the first embodiment, the contact of the steam-cleaned flag M100 is described in the IL circuit 581 of the program PGM002. Therefore, in the present embodiment, Y1000 (the instruction signal that sets VLV1 to OPEN) will not be ON unless the steam-cleaned flag M100 is ON.

Next, the processing procedure related to the program file generation processing according to the present embodiment will be described with reference to FIG. 15. The processing from the data storage step S1 to the program generation step S4 in the program file generation processing according to the present embodiment is the same as in the first embodiment. Hereinafter, the IL addition step S5 and thereafter according to the present embodiment will be described.

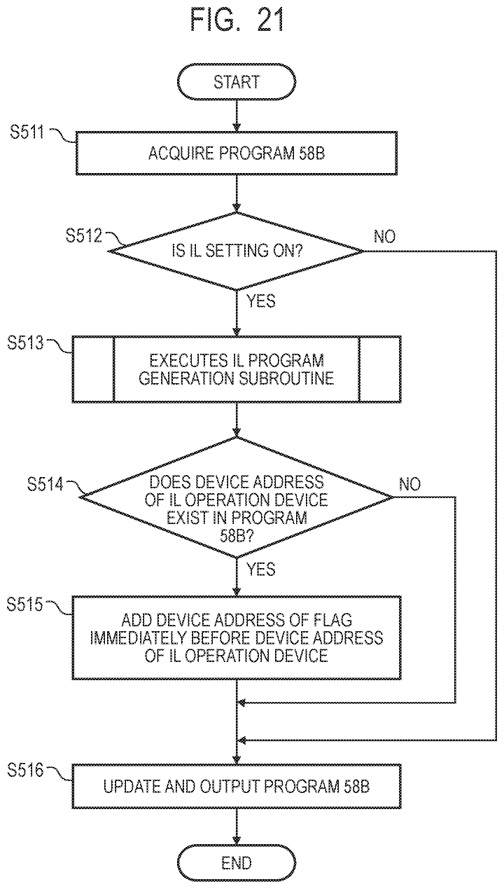

First, the IL addition processing in the IL addition step S5 according to the present embodiment will be described with reference to FIG. 21. FIG. 21 is a flowchart illustrating the procedure of the IL addition processing according to the present embodiment. In the present embodiment, the IL is added to the program 58B based on the steam-cleaned flag as follows.

As illustrated in FIG. 21, first, in step S511, the IL generation unit 63 acquires the program 58B to which the IL is to be added, as in step S501 of the first embodiment.

Next, the IL generation unit 63 performs from step S512 to step S515 for all the overlapping devices registered in the IL address information 575.

In step S512, the IL generation unit 63 refers to the IL setting information (not illustrated) for the overlapping devices and confirms whether or not the IL setting is set to be enabled, in the same manner as in step S502 of the first embodiment. When the IL setting is set to be enabled, the IL generation unit 63 makes the processing proceed to step S513. When the IL setting is not set to be enabled, the IL generation unit 63 makes the processing proceed to step S516.

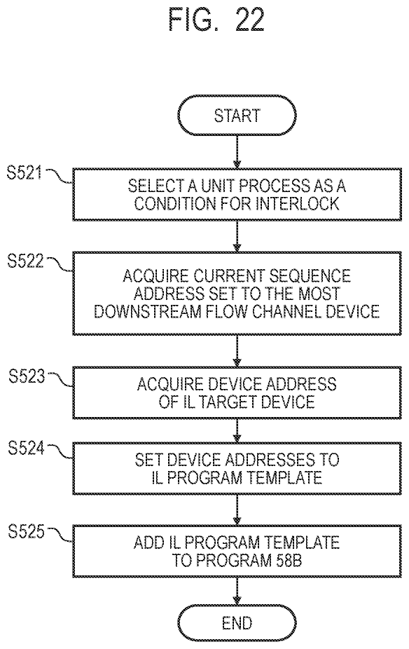

When the IL setting is set to be enabled, in step S513, the IL generation unit 63 executes an IL program generation subroutine to generate a program that manages the flag 568 which is the steam-cleaned flag. The IL program generation subroutine will be described with reference to FIG. 22. FIG. 22 is a flowchart illustrating the procedure of the IL program generation subroutine.

As illustrated in FIG. 22, in step S521, the IL generation unit 63 selects a unit process as a condition for interlock. Here, the IL generation unit 63 selects a step (steam cleaning) in which the operation sequence 201 in the process table 2 illustrated in FIG. 18 is “4”. The selection of the unit process can be completed by the user interface unit 4 displaying the process table 2 in the display unit 100 and the user selecting the unit process in the process table 2 with the input unit 200 such as a mouse. Note that, in the present embodiment, the steam cleaning step is the unit process that should be the condition for interlock, but in other embodiments, the user can arbitrarily select the unit process that should be the condition for interlock.

Next, in step S522, the IL generation unit 63 acquires the device address necessary for confirming the completion of the processing of the unit process selected in step S521. At this time, the device address necessary for confirming the completion of the processing of the unit process is the current sequence address set to the most downstream device with the control signal among the flow channel devices. Taking the flow channel FLW5 of FIG. 17B as an example, the steam source STEAM1, the pump PMP3, the valve VLV4, the valve VLV3, and the TNK3 are stored in the flow channel device 532. The tank TNK3 has no control signal. Therefore, the IL generation unit 63 acquires the current sequence address set to the program of the valve VLV3 as the device address necessary for confirming the completion of the processing of the unit process. This is M13 in the program PGM007 of the program 58B.

Next, in step S523, the IL generation unit 63 refers to the device address table 54 and acquires the device address 544 that notifies the PLC 1001 of the OFF state among the control signals of the IL target devices. The device address 544 that notifies the PLC 1001 of the OFF state is the device address 544 having the input/output attribute 542 of “IN” and the operation state 543 of “OFF”.

In step S524, the IL generation unit 63 sets the device addresses acquired in step S522 and step S523 to the IL program template 565. Here, the IL generation unit 63 sets the current sequence address acquired in step S522 to the cleaning sequence address and the device address acquired in step S523 to the control signal of the IL target device. Further, the IL generation unit 63 sets the IL device address 553 that is unused to the flag 568.

Next, in step S525, the program file generation unit 61 adds the IL program template 565 with the device address set to the program 58B and ends the processing.

When the above IL program generation subroutine is completed, the IL addition processing proceeds to step S514. The IL generation unit 63 performs step S514 and step S515 for all the overlapping devices registered in the IL address information 575.

In step S514, the IL generation unit 63 searches for the device address of the IL operation device in the program 58B. When there is the device address of the IL operation device in the program 58B, the IL generation unit 63 makes the processing proceed to step S515, otherwise the IL generation unit 63 makes the processing proceed to step S516.

In step S515, the IL generation unit 63 adds a contact immediately before the device address of the IL operation device 576 in the program 58B and sets the device address of the flag to it.

In step S516, the program file generation unit 61 creates the program file 1000 in which the program 58B updated by step S512 to step S515 is converted into a format that can be interpreted and executed by the PLC 1001. Subsequently, the created program file 1000 is outputted to the outside so that the PLC 1001 can use the program file 1000. Note that, in the present embodiment, as in the first embodiment, the program 58B can be displayed on the display unit 100 and the IL portion added in the IL adding process S5 can be emphatically displayed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. According to the present invention, it is possible to generate a program capable of easily setting a constraint condition to be set by an operator for a process to be performed by an apparatus having a flow channel structure, and preventing unintentional mixing of fluids in a channel in the flow channel structure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-193783, filed Dec. 2, 2022, which is hereby incorporated by reference herein in its entirety.

What is claimed is:

1. An information processing apparatus comprising a processing unit that generates a program to cause an apparatus having a flow channel structure including a plurality of flow channels to perform a plurality of processes,
wherein the processing unit:
generates a plurality of pieces of flow channel setting information based on device information that represents the flow channel structure and the flow channels used in the flow channel structure in the plurality of processes;
generates interlock control information for interlock control for a predetermined flow channel based on the plurality of pieces of flow channel setting information; and
generates the program to which the interlock control is added based on the interlock control information.

2. The information processing apparatus according to claim 1, wherein the predetermined flow channel is an overlapping flow channel in which at least two flow channels overlap.

3. The information processing apparatus according to claim 2, wherein the processing unit generates the interlock control information when fluids that differ from each other flow in the overlapping flow channel.

4. The information processing apparatus according to claim 1, wherein the device information includes switching attribute information that indicates whether or not a device in the flow channel structure has a switching attribute that switches the flow channel, and
wherein the processing unit:
generates the plurality of pieces of flow channel setting information including the switching attribute information; and
generates the interlock control information based on the plurality of pieces of flow channel setting information including the switching attribute information.

5. The information processing apparatus according to claim 4, wherein the processing unit generates, for a plurality of the devices having the switching attributes, the interlock control information including information indicating relationship between one device that operates when the interlock control is activated and another device that is controlled exclusively with the one device.

6. The information processing device according to claim 1, comprising a display unit and an input unit,
wherein the processing unit displays the interlock control information on the display unit and receives input from the input unit to enable or disable the interlock control.

7. The information processing apparatus according to claim 2, wherein the processing unit adds the interlock control to the program based on a flag indicating whether or not the interlock control is performed for a predetermined process in the plurality of processes when fluids that differ from each other flow in the overlapping flow channel.

8. The information processing apparatus according to claim 7, wherein the predetermined process is a cleaning process of a pipe.

9. The information processing apparatus according to claim 1, wherein the processing unit generates the program that can be executed by a control apparatus that controls the apparatus.

10. The information processing apparatus according to claim 9, wherein the control apparatus is a programmable logic controller, and
wherein the program is a ladder program that can be executed by the programmable logic controller.

11. An information processing method with a computer that generates a program to cause an apparatus having a flow channel structure including a plurality of flow channels to perform a plurality of processes, wherein the computer:
generates a plurality of pieces of flow channel setting information based on device information that represents the flow channel structure and the flow channels used in the flow channel structure in the plurality of processes;
generates interlock control information for interlock control for a predetermined flow channel based on the plurality of pieces of flow channel setting information; and
generates the program to which the interlock control is added based on the interlock control information.

12. The information processing method according to claim 11, wherein the predetermined flow channel is an overlapping flow channel in which at least two flow channels overlap.

13. The information processing method according to claim 12, wherein the computer generates the interlock control information when fluids that differ from each other flow in the overlapping flow channel.

14. The information processing method according to claim 11, wherein the device information includes switching attribute information that indicates whether or not a device in the flow channel structure has a switching attribute that switches the flow channel, and
wherein the computer:
generates the plurality of pieces of flow channel setting information including the switching attribute information; and
generates the interlock control information based on the plurality of pieces of flow channel setting information including the switching attribute information.

15. The information processing method according to claim 14, wherein the computer generates, for a plurality of the devices having the switching attributes, the interlock control information including information indicating relationship between one device that operates when the interlock control is activated and another device that is controlled exclusively with the one device.

16. The information processing method according to claim 12, wherein the computer adds the interlock control to the program based on a flag indicating whether or not the interlock control is performed for a predetermined process in the plurality of processes when fluids that differ from each other flow in the overlapping flow channel.

17. The information processing method according to claim 16, wherein the predetermined process is a cleaning process of a pipe.

18. The information processing method according to claim 11, wherein the computer generates the program that can be executed by a control apparatus that controls the apparatus.

19. A control method of a control apparatus, the control method comprising:
with the information processing method according to claim 11, a computer generating the program; and
the computer causing the control apparatus to read the program to make the apparatus perform the plurality of processes.

20. A non-transitory computer-readable storage medium storing a program for causing a computer to execute the information processing method according to claim 11.
